(19) United States
(12) Patent Application Publication
(10) Pub. No.: US 2002/0089850 A1
(43) Pub. Date: Jul. 11, 2002

(54) String of ornamental light

(76) Inventor: Jessica Wang, Taipei (TW)

Correspondence Address: OSTROLENK FABER GERB & SOFFEN, 1180 AVENUE OF THE AMERICAS, NEW YORK, NY, 100368403

(21) Appl. No.: 09/755,476

(22) Filed: Jan. 5, 2001

(51) Int. Cl. F21V 21/00

(52) U.S. Cl. 362/252; 362/249; 362/391

(57) ABSTRACT

A string of ornamental lights has multiple layers of lights each layer having four lights and each light being provided with a bulb, a holder for receiving the bulb therein and three auxiliary wires one of which is directly or indirectly connected with the first wire or the second wire and the other two are electrically connected with other holders. With such an arrangement, the ornamental effect is enhance.

### BACKGROUND OF THE INVENTION

1. Field of the Invention

The present invention relates to a string of ornamental light, and more particularly to multiple ornamental lights are connected together by wires into a string, such that the ornamental effect is enhanced.

2. Description of Related Art

Ornamental light string is popular in seasonal festival, especially in Christmas Day. People use ornamental light string to decorate the Christmas tree, the roof and windows to share the seasonal joy with others. The conventional ornamental light string has a plug intended to be electrically connected with a power source, such as an outlet, multiple light bulbs securely and electrically connected with one another by wires. Each of the light bulbs has a retaining device securely connected with the light bulb and configured to connect the wires into a net-like structure. That is, after the wire is connected with the light bulb, the retaining device functions as a joint between the wire and the light bulb. With the retaining device, the wires are mutually connected together, such that when the ornamental light string of this kind spreads, it is quite easy for the user to hang it over the tree, the roof or any thing required.

However, with this type of ornamental light string, the user will have to prepare multiple wires not only to electrically connect to the light bulb, but also to string the light bulbs into a net-like structure. Accordingly, the total length of the wires is long and inevitably the cost for manufacturing this kind of light string is high.

Furthermore, because the light bulbs are mutually connected with each other by means of the wires and it is well known that the strength of the wire can not resist pulling and stretching, this kind of ornamental light string hanging on a tree or even dangling in the air will easily breaks and thus causes a short.

To overcome the shortcomings the present invention intends to provide an improved ornamental light string to mitigate or obviate the aforementioned problems.

### SUMMARY OF THE INVENTION

The primary objective of the: invention is to provide an ornamental light string by connecting multiple light bulbs together by wires. Each of the light bulbs have a clamp formed on a side of the light bulb for engaging with a wire passing through the light bulb. With such an arrangement, the light and the ornamental effect are both enhanced.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the ornamental light string constructed in accordance with the present invention;

FIG. 2 is a perspective view showing one ornamental light bulb used in the ornamental light string of FIG. 1; and

FIG. 3 is a schematic view showing the application of the string of ornamental light.

### DETAILED DESCRIPTION OF PREFERRED EMBODIMENT

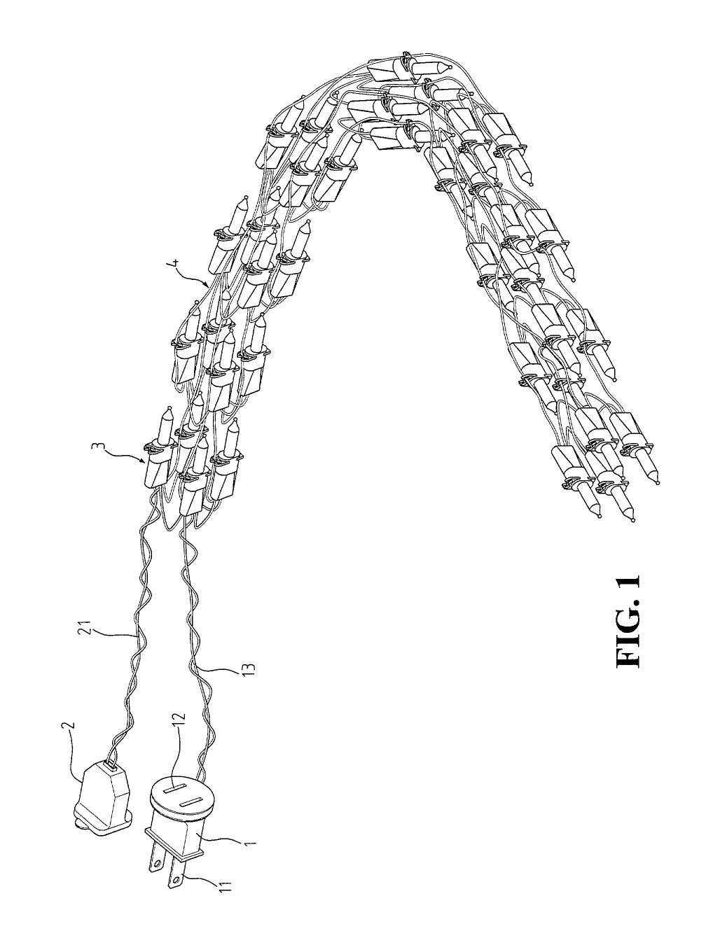

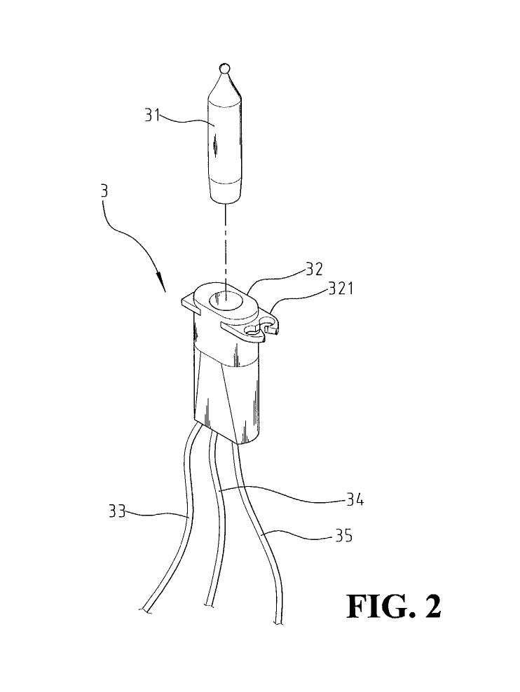

With reference to FIGS. 1 and 2, a string of ornamental light in accordance with the present invention has a plug (1), a socket (2) and multiple lights (3) each electrically connected with one another by wires (4).

The plug (1) has a pair of pins (11), two slits (12) defined to allow an electrical connection with the pins (11) of another plug (1) and two first wires (13).

The socket (2) has two second wires (21) extending out therefrom.

The multiple ornamental lights (3) each having a light bulb (31), a holder (32) for receiving the light bulb (31) therein and three auxiliary wires (33,34,35) one of which is directly or indirectly connected with one of either the first wire (13) or the second wires (21) and the other are electrically connected with other holders (32).

Each holder (32) has a retainer (321) formed on a side thereof for clamping the first wire. (13), the second wire (21 ) or the wire (4) passing thereby. It is to be noted from the drawings that the string of ornamental lights has multiple layers of ornamental lights. Each layer of the ornamental lights has four lights (3) each light (3) electrically connected with one another in parallel. Each layer of the ornamental lights is connected with another layer of the ornamental lights in series.

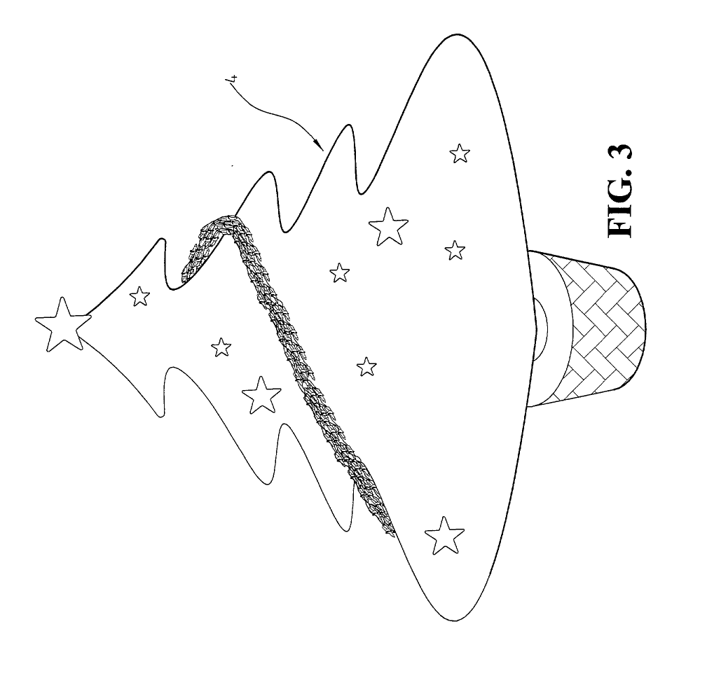

When the string of ornamental lights is applied onto such as a Christmas tree (4), as shown in FIG. 3, the ornamental effect is enhanced.

Even though numerous characteristics and advantages of the present invention have been set forth in the foregoing description, together with details of the structure and function of the invention, the disclosure is illustrative only, and changes may be made in detail, especially in matters of shape, size; and arrangement of parts within the principles of the invention to the fill extent indicated by the broad general meaning of the terms in which the appended claims are expressed.

What is claimed is:

1. A string of ornamental lights comprising:
a plug having a pair of pins configured to connect with a power source, two slits defined to allow an electrical connection with the pins of another plug and two first wires;
a socket having two second wires extending out therefrom;
multiple layers of ornamental lights each layer having four lights and each light provided with a bulb, a holder for receiving the bulb therein and three auxiliary wires one of which is directly or indirectly connected with one of either the first wire (13) or the second wires (21) and the other arc electrically connected with other holders (32); wherein a retainer is formed on a side of the holder for receiving the first wire, the second wire or one of the three auxiliary wires.
